(19) United States
(12) Patent Application Publication
(10) Pub. No.: US 2023/0399196 A1
(43) Pub. Date: Dec. 14, 2023

(54) ROBOT-SPECIFIC ELEVATOR SYSTEMS

(71) Applicant: Otis Elevator Company, Farmington, CT (US)

(72) Inventors: Nick Cope, Brooklyn, NY (US); Arthur Hsu, South Glastonbury, CT (US)

(21) Appl. No.: 17/752,343

(22) Filed: May 24, 2022

(51) Int. Cl. B66B 1/46; B66B 1/24; B66B 1/34

(52) U.S. Cl. CPC B66B 1/468; B66B 1/2408; B66B 2201/104; B66B 2201/4653; B66B 1/3461

(57) ABSTRACT

Building systems and method of using elevators in buildings are described. The systems include a robot-use elevator system having an elevator car moveable along an elevator shaft of a building, a controller configured to receive requests associated with the elevator system and configured to control operation of the elevator system, and a robot configured in communication with the controller and configured to perform actions within the building, the robot configured to travel within the building in the elevator car. The elevator car is operated using parameters outside limits intended for human use of an elevator car.

### BACKGROUND

Embodiments described herein relate to building systems and, more specifically, to elevator systems and building maintenance operations that incorporate a robot to perform actions associated therewith and elevator systems for such robots.

Autonomous mobile robots or service robots are on the rise in a variety of industries including commercial buildings, hospitality, healthcare, and the like. Such robots can perform actions either to replace existing human activity or to supplement such activity by enabling specific tasks or procedures that may be unsafe, difficult to perform, occur in hard to reach locations, or the like, or may be implemented to streamline existing processes. Use of such robots in building maintenance operations may be beneficial.

### BRIEF SUMMARY

In accordance with some embodiments, building systems are provided. The building systems includes a robot-use elevator system having an elevator car moveable along an elevator shaft of a building, a controller configured to receive requests associated with the elevator system and configured to control operation of the elevator system, and a robot configured in communication with the controller and configured to perform actions within the building, the robot configured to travel within the building in the elevator car. The elevator car is operated using parameters outside limits intended for human use of an elevator car.

In addition to one or more of the features described above, or as an alternative, further embodiments of the building systems may include that the parameters comprises at least one of elevator travel speed, elevator acceleration rate, elevator deceleration rate, elevator jerk, and elevator leveling at a landing.

In addition to one or more of the features described above, or as an alternative, further embodiments of the building systems may include that the parameters comprises at least one of climate control within the elevator car and lighting within the elevator car.

In addition to one or more of the features described above, or as an alternative, further embodiments of the building systems may include that the elevator car is a robot-use elevator car configured to transport robots and not humans.

In addition to one or more of the features described above, or as an alternative, further embodiments of the building systems may include that the robot-use elevator car does not include at least one of a car operating panel, an in-car display, an in-car speaker, and in-car microphone for voice communication, or a hall call panel.

In addition to one or more of the features described above, or as an alternative, further embodiments of the building systems may include that the robot-use elevator car is sized for carrying the robot and not humans.

In addition to one or more of the features described above, or as an alternative, further embodiments of the building systems may include that the robot is configured to make elevator call requests to the controller through a wireless communication.

In addition to one or more of the features described above, or as an alternative, further embodiments of the building systems may include that the controller is configured to verify that a request for use of the elevator car is made by the robot as compared to a human request.

In addition to one or more of the features described above, or as an alternative, further embodiments of the building systems may include that the controller is configured to verify that no humans are present in the elevator car prior to causing movement thereof.

In addition to one or more of the features described above, or as an alternative, further embodiments of the building systems may include that the robot-use elevator system does not include a hall call panel for human-use calling of the elevator car at one or more floors where the elevator can be called by the robot.

In addition to one or more of the features described above, or as an alternative, further embodiments of the building systems may include that the robot is configured to perform a handshake operation with the controller prior to traveling within the elevator car, and wherein the elevator car is configured to not travel if the handshake operation is not performed.

According to some embodiments, methods of controlling elevator systems are provided. The methods include receiving a request for elevator service from a robot at a controller, dispatching an elevator car to a location associated with the request for elevator service, and operating the elevator car using parameters outside limits intended for human use of an elevator car.

In addition to one or more of the features described above, or as an alternative, further embodiments of the methods may include that the parameters comprises at least one of elevator travel speed, elevator acceleration rate, elevator deceleration rate, elevator jerk, and elevator leveling at a landing.

In addition to one or more of the features described above, or as an alternative, further embodiments of the methods may include that the parameters comprises at least one of climate control within the elevator car and lighting within the elevator car.

In addition to one or more of the features described above, or as an alternative, further embodiments of the methods may include that the elevator car is a robot-use elevator car configured to transport robots and not humans.

In addition to one or more of the features described above, or as an alternative, further embodiments of the methods may include that the robot-use elevator car does not include at least one of a car operating panel, an in-car display, an in-car speaker, an in-car microphone for voice communication, or a hall call panel.

In addition to one or more of the features described above, or as an alternative, further embodiments of the methods may include that the robot-use elevator car is sized for carrying the robot and not humans.

In addition to one or more of the features described above, or as an alternative, further embodiments of the methods may include transmitting from the robot a handshake request to the controller prior to operating the elevator car.

In addition to one or more of the features described above, or as an alternative, further embodiments of the methods may include verifying, with the controller, that a request for use of the elevator car is made by the robot as compared to a human.

In addition to one or more of the features described above, or as an alternative, further embodiments of the methods may include verifying that no humans are present in the elevator car prior to causing operation thereof.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The subject matter which is regarded as the invention is particularly pointed out and distinctly claimed in the claims at the conclusion of the specification. The foregoing and other features and advantages of the invention are apparent from the following detailed description taken in conjunction with the accompanying drawings in which:

FIG. 1 is a schematic illustration of an elevator system that may employ various embodiments of the present disclosure;

FIG. 2 is a schematic illustration of a building system having a robot, controller, and elevator system in accordance with an embodiment of the present disclosure; and

FIG. 3 is a schematic illustration of a building system having a robot, controller, and elevator system in accordance with an embodiment of the present disclosure; and

FIG. 4 is a flow process for controlling a building elevator system in accordance with an embodiment of the present disclosure.

### DETAILED DESCRIPTION

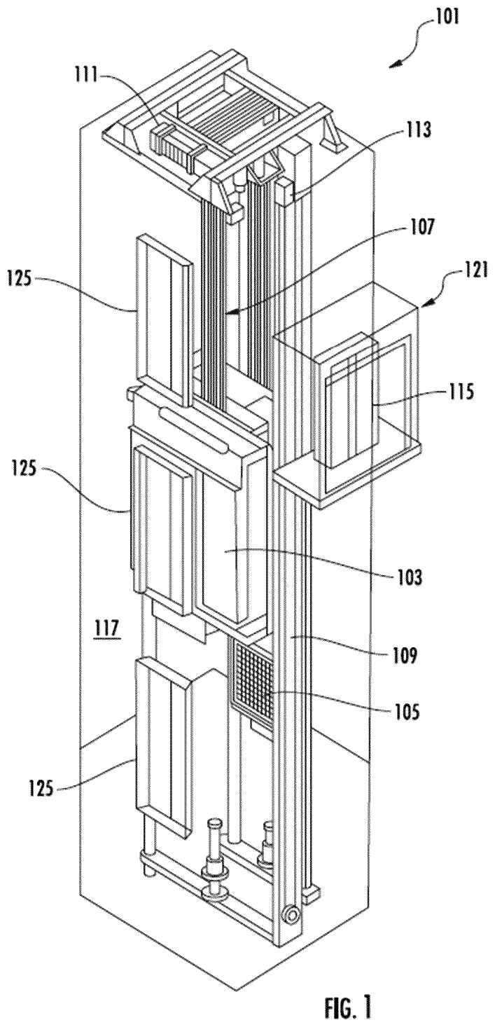

FIG. 1 is a perspective view of an elevator system 101 including an elevator car 103, a counterweight 105, a tension member 107, a guide rail 109, a machine 111, a position reference system 113, and a controller 115. The elevator car 103 and counterweight 105 are connected to each other by the tension member 107. The tension member 107 may include or be configured as, for example, ropes, steel cables, and/or coated-steel belts. The counterweight 105 is configured to balance a load of the elevator car 103 and is configured to facilitate movement of the elevator car 103 concurrently and in an opposite direction with respect to the counterweight 105 within an elevator shaft 117 and along the guide rail 109.

The tension member 107 engages the machine 111, which is part of an overhead structure of the elevator system 101. The machine 111 is configured to control movement between the elevator car 103 and the counterweight 105. The position reference system 113 may be mounted on a fixed part at the top of the elevator shaft 117, such as on a support or guide rail, and may be configured to provide position signals related to a position of the elevator car 103 within the elevator shaft 117. In other embodiments, the position reference system 113 may be directly mounted to a moving component of the machine 111, or may be located in other positions and/or configurations as known in the art. The position reference system 113 can be any device or mechanism for monitoring a position of an elevator car and/or counter-weight, as known in the art. For example, without limitation, the position reference system 113 can be an encoder, sensor, or other system and can include velocity sensing, absolute position sensing, etc., as will be appreciated by those of skill in the art.

The controller 115 is located, as shown, in a controller room 121 of the elevator shaft 117 and is configured to control the operation of the elevator system 101, and particularly the elevator car 103. For example, the controller 115 may provide drive signals to the machine 111 to control the acceleration, deceleration, leveling, stopping, etc. of the elevator car 103. The controller 115 may also be configured to receive position signals from the position reference system 113 or any other desired position reference device. When moving up or down within the elevator shaft 117 along guide rail 109, the elevator car 103 may stop at one or more landings 125 as controlled by the controller 115. Although shown in a controller room 121, those of skill in the art will appreciate that the controller 115 can be located and/or configured in other locations or positions within the elevator system 101. In one embodiment, the controller may be located remotely or in the cloud.

The machine 111 may include a motor or similar driving mechanism. In accordance with embodiments of the disclosure, the machine 111 is configured to include an electrically driven motor. The power supply for the motor may be any power source, including a power grid, which, in combination with other components, is supplied to the motor. The machine 111 may include a traction sheave that imparts force to tension member 107 to move the elevator car 103 within elevator shaft 117.

Although shown and described with a roping system including tension member 107, elevator systems that employ other methods and mechanisms of moving an elevator car within an elevator shaft may employ embodiments of the present disclosure. For example, embodiments may be employed in ropeless elevator systems using a linear motor to impart motion to an elevator car. Embodiments may also be employed in ropeless elevator systems using a hydraulic lift to impart motion to an elevator car. FIG. 1 is merely a non-limiting example presented for illustrative and explanatory purposes.

Autonomous mobile robots or service robots may be used in commercial buildings. Such uses may be related to hospitality (e.g., for food and package delivery, concierge and guest services, and the like), healthcare (e.g., for medicine and supply delivery and service augmentation), and the like. Additionally, robots and other autonomous systems (e.g., drones or the like) may be used for inspection, safety, and/or service purposes. Robots may be used with elevator systems of buildings for the purpose of inspection, repair, maintenance, monitoring, delivery and/or transport of items throughout the building, and the like.

For example, robots can be used for the purpose of inspection, maintenance, delivery/transport of items, and/or verification of certain elevator system issues and/or systems related to a building. In some such configurations, the robot(s) may be configured to operate as part of a technical partnership between the robot(s) and an IoT (internet-of-things) monitoring system associated with an elevator system. In some such applications, the IoT monitoring system may be configured to detect an anomaly of the elevator system that may be an early indicator of an issue with elevator equipment and/or operation. In response to such detection, a robot may be used (e.g., dispatched) to inspect and/or verify the anomaly and/or the nature of such anomaly. The robot may be configured to place hall or car calls via an elevator dispatch API, in response to the anomaly detection. It accordance with some embodiments of the present disclosure, the call that is placed by the robot may be made through a mechanism not available to humans—e.g., wirelessly, through physical input/interface device, or the like. In some embodiments, the request may be a communication exchange that includes a request, verification, and dispatch process, or the like.

The robot may then travel to a position such that the robot can perform a verification or data gathering task. That is, the robot may communicate and/or interact with the elevator system to call an elevator car and travel in such elevator car to a designated location to perform an inspection or other task. In embodiments where the robot is configured to perform a task not directly associated with the elevator system, the robot may be able to make calls for elevator travel between floors of the building to perform a task on the destination floor(s). As used herein, the term “elevator car” includes enclosed cabs, open platforms, and the like, and is not to be limited to an enclosed cab-type configuration. This is particularly true because, as described herein, the elevator cars may be modified for use by and with robots.

In some applications, the robot(s) may be configured to place hall or car calls as part of a routine task cycle for gathering data on certain equipment health indicators. In some such applications, the robot(s) may be configured to analyze vibrations of an elevator door via an on-board camera or other sensor of the robot. In such gathering data applications, the robot(s) may be configured to perform a series of monitoring activities (e.g., visual, vibration, etc.) associated with the elevator system. This process can help determine whether an action is needed to resolve an issue. For example, a robot may be configured to trigger a notification or directly place a service request via the elevator IoT monitoring system, through a work order management system of a building, or the like. The robot may also be configured to collect data associated with an inspection and service request to provide additional information beyond a mere call for service to be performed.

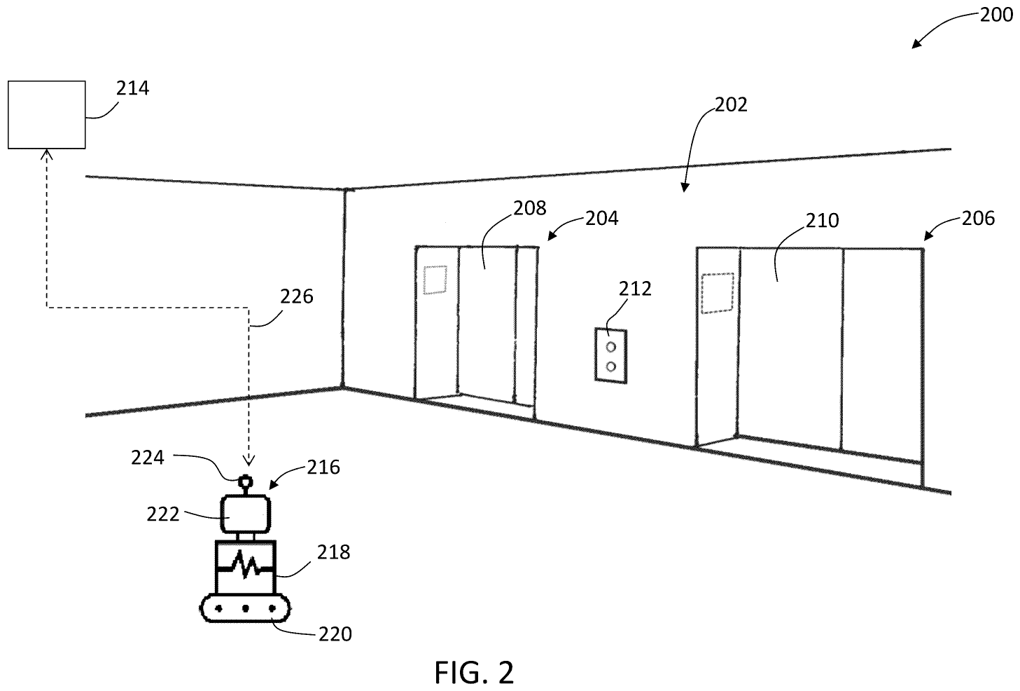

Referring now to FIG. 2, a schematic illustration of a building system 200 in accordance with an embodiment of the present disclosure is shown. FIG. 2 illustrates one landing of an elevator system 202 of the building system 200, having two elevators 204, 206 with respective elevator landing doors 208, 210. The elevator system 202 may include a plurality of landings with one or more elevator shafts and associated elevators configured to provide access to and transportation between the landings of the elevator system. The elevators 204, 206 may each be arranged similar to the elevator system 101 shown and described with respect to FIG. 1. The elevators 204, 206 may be called to each landing of the elevator system 202 using a hall call panel 212 located at each landing or as described herein. When an elevator car of the respective elevator 204, 206 reaches a landing where a request was made (e.g., either at the landing or from within the elevator car), the respective elevator landing door 208, 210 will open to permit entry and exiting to and from the elevator car, as will be appreciated by those of skill in the art.

The building system 200 also includes a controller 214. The controller 214 may be part of a building-integrated system that is configured to monitor various aspects of a building, including, but not limited to, the elevator system 202. In some embodiments, the controller 214 may be an elevator controller (e.g., controller 115 of FIG. 1). In some configurations, the controller 214 may be operably connected to or part of a building monitoring system and/or an internet-of-things (IoT) system that incorporates a network and associated communication lines (e.g., wired and/or wireless) for obtaining information from a distributed set of sources (e.g., sensors, monitoring systems, control systems, HVAC systems, elevator systems, security systems, lighting systems, etc.).

In accordance with embodiments of the present disclosure, the building system 200 also includes at least one robot 216. The robot 216 may be an autonomous or semi-autonomous system that is configured to travel throughout the building and perform tasks, such as inspection, monitoring, data collection, perform maintenance, item delivery and/or transport, etc. In this illustrative embodiment, the robot 216 includes a main body 218 that houses various electronics and/or mechanism systems, such as for locomotion, data collection, interaction with external items, and the like. The robot 216 includes a means for locomotion 220, such as treads, wheels, roller balls, articulated legs/arms, or the like. The robot 216 includes a sensor assembly 222, which can include various sensors, appendages, tools, processing components, and the like. The robot 216 includes a communications element 224 that is configured to communicate with the controller 214 along a communication line 226. It will be appreciated that the robot 216 is merely schematically shown as a cartoon representation with discrete parts and that the robots of the present disclosure may take any structural form or arrangement of components (e.g., all or some integrated into a single housing or the like). The communication line 226 may be a wireless communication connection and/or the robot 216 may be configured to hardwire connect to a communication port or line to enable communication between the robot 216 and the controller 214.

The robot 216 and/or the controller 214 can include electronics that include processor(s), memory, communication module(s), etc. as will be appreciated by those of skill in the art. The robot 216 can be configured to communicate with one or more system components, such as computers, controllers, etc. of the controller 214. The system components can include processors, memory, communications modules, etc. As noted, the communication between the robot 216 and the controller 214 can be by wired or wireless communication, through the internet, direct connection, etc. as will be appreciated by those of skill in the art.

The robot 216 and the controller 214, in accordance with embodiments of the present disclosure, can communicate with one another along the communication line 226. For example, in some configurations, the two components (i.e., the robot 216 and the controller 214) may communicate with one another when the robot 216 is located in proximity to an access or connection point (e.g., wireless access point or wired port) and/or through network communication. Wireless communication networks can include, but are not limited to, Wi-Fi, short-range radio (e.g., Bluetooth®), near-field infrared, cellular network, etc. In some embodiments, the controller 214 may include, or be associated with (e.g., communicatively coupled to) one or more networked system elements, such as computers, routers, network nodes, etc. The networked system elements may also communicate directly or indirectly with the robot 216 using one or more communication protocols or standards (e.g., through the communication line 226).

For example, communication between the controller 214 or a component thereof and the robot 216 may be accomplished using near-field communications (NFC) or other wireless connection mechanisms/protocols (e.g., communication line 226) and thus enable communication between the robot 216 and the controller 214. Additional connections and/or means of determining position can be established with various technologies including, for example and without limitation, Wi-Fi, short-range radio (e.g., Bluetooth®), near-field infrared, cellular network, GPS, triangulation, signal strength detection, etc. Such technologies that allow communication can provide users and the system(s) described herein time to perform the described functions. In example embodiments, the robot 216 may communicate with the controller 214 over multiple independent wired and/or wireless networks. Embodiments are intended to cover a wide variety of types of communication between the robot 216 and the controller 214, and embodiments are not limited to the examples provided in this disclosure.

As noted above, the communication line 226 may be a communication network. Such network may be any type of known communication network including, but not limited to, wide area networks (WAN), local area networks (LAN), global networks (e.g., Internet), virtual private networks (VPN), cloud networks, intranet, etc. Such network may be implemented using a wireless network or any kind of physical network implementation known in the art. The robot 216 and potentially other robots and/or other devices may be coupled to the controller 214 through one or more networks (e.g., a combination of cellular and Internet connections) so that not all communication connections may be the same (or used at the same time). In one non-limiting embodiment, the network (e.g., communication line 226) is the Internet and one or more of the robots 216 are configured to communicate with the controller 214 through the network (e.g., using communications element 224).

The controller 214 may include a control component(s) (e.g., single computer or server, distributed computing system, remote networked system, etc.) that is configured to receive requests for elevator operation, among other requests and/or purposes. Requests may be received from the robot 216 through the communication line 226 during the course of operation of the robot 216. The controller 214 may also include a memory or other digital storage (local or remote from the building) that contains a database having one or more procedures (e.g., a sequence of tasks) and/or instructions for operation(s). The communication line 226 provides for a communication channel between the controller 214 and the robot 216.

In some embodiments, the controller 214 and/or the robot 216 may include or be configured to access a database containing one or more maintenance procedures. The maintenance procedures may be a series of executable commands or sequences of tasks to be performed by the controller and/or the robot. For example, in some embodiments, the maintenance procedures can include data analysis at the controller or the robot. Further, such maintenance procedures may include instructions to be transmitted to (or stored on) the robot to be carried out or performed by the robot. Such instructions can include location data (e.g., where the robot should go) and task data (e.g., executable instructions to perform an action). As such, the robot may be able to travel and perform a task in response to receiving one or more instructions that may be part of a maintenance procedure. The tasks may include data collection using one or more sensors of the robot, the robot interfacing with other systems to download or obtain data and information from such other systems, performing an inspection and/or maintenance operation, or the like.

In operation, the robot 216 may be configured to collect sensor data using the sensor assembly 222. The robot 216 may thus be configured to transmit or otherwise communication information from the robot 216 to a central location for processing of such information. The controller 214 may also be operably connected to and/or in communication with the elevator system 202 (e.g., an elevator controller). From this connection, the controller 214 may be configured to obtain information directly associated with the elevator system 202 (e.g., sensors on elevator cars, elevator motor or machine, etc.). The controller 214 may be configured to obtain the collected information from the robot 216 (e.g., sensor data) and the elevator system 202 (e.g., elevator data) to determine if elevator operation is nominal or requires further action.

The sensor assembly 222 of the robot 216 may include one or more sensors that are configured to enable detection and/or monitoring of systems and components associated with the elevator system 202. For example, the sensor assembly 222 may include, without limitation, optical sensors, accelerometers, acoustic and/or vibration sensors, temperature sensor, air quality sensors, motor current/feedback sensors, ultrasonic sensors, or radar sensors, and the like. Optical sensors and the like may be configured to detect lighting associated with the elevator system 202 (e.g., in-car lights, lights on operating panels, lights at landings, etc.). Such optical sensors may also be configured video analytics, such as a video for damage analysis, identifying debris, spills, a passed out passenger, left behind items, or the like. Accelerometers and similar sensors may be used to detect a level of an elevator car with a landing (e.g., for entering/exiting), smoothness of elevator ride, detecting stopping/starting acceleration of an elevator car, or the like. Air quality sensors may be configured to monitor temperature, odors, ventilation (e.g., CO₂), smoke, the presence of chemical and/or biological agents, and the like. Ultrasonic or radar (e.g., range detection) may be used to determine if the elevator car is level with a landing or not and/or may be used to detect objects left behind in elevator car or at a landing. The above description provides a limited number of examples of types of sensors and use thereof. It will be appreciated that additional sensors and/or functionality may be implemented without departing from the scope of the present disclosure.

The robot 216 may be configured or programmed to travel through a building and perform inspections, maintenance, other tasks, item delivery and/or transport, or the like. Through the communication line 226, the robot 216 may be configured to call an elevator car to a particular landing. The call may be placed from the robot 216 to the controller 214 which in turn interfaces with an elevator controller to send an elevator car to a requested landing. In other embodiments, the robot 216 may directly make an elevator call through the communication line 226 if such communication line is connected directly to the elevator controller. In still other embodiments, in combination or alternatively, the robot 216 may request an elevator car using the hall call panel 212 or a car operating panel (if the robot is already within an elevator car and a destination landing is selected).

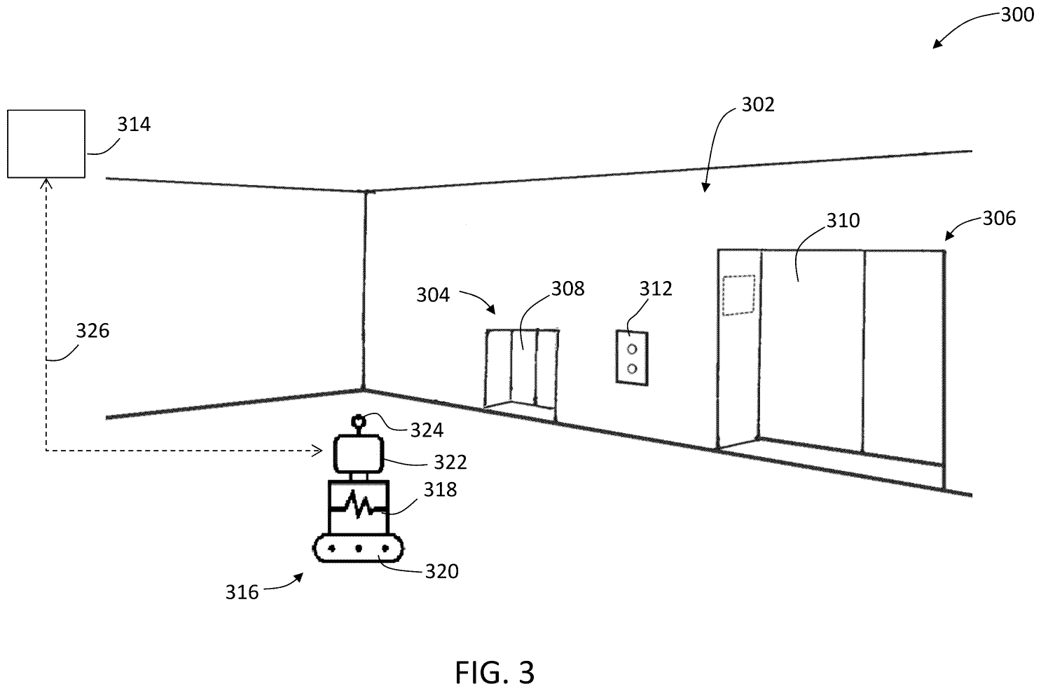

Referring now to FIG. 3, a schematic illustration of a building system 300 in accordance with an embodiment of the present disclosure is shown. FIG. 3 illustrates one landing of an elevator system 302 of the building system 300, having two elevators 304, 306 with respective elevator landing doors 308, 310. The elevator system 302 may include a plurality of landings with one or more elevator shafts and associated elevators configured to provide access to and transportation between the landings of the elevator system. The elevators 304, 306 may each be arranged similar to the elevator system 101 shown and described with respect to FIG. 1. The elevators 304, 306 may be called to each landing of the elevator system 302 using a hall call panel 312 located at each landing or as described herein. When an elevator car of the respective elevator 304, 306 reaches a landing where a request was made (e.g., either at the landing or from within the elevator car), the respective elevator landing door 308, 310 will open to permit entry and exiting to and from the elevator car, as will be appreciated by those of skill in the art.

The building system 300 includes a controller 314. The controller 314 may be part of a building-integrated system that is configured to monitor various aspects of a building, including, but not limited to, the elevator system 302. In some embodiments, the controller 314 may be an elevator controller (e.g., controller 115 of FIG. 1). In some configurations, the controller 314 may be operably connected to or part of a building monitoring system and/or an internet-of-things (IoT) system that incorporates a network and associated communication lines (e.g., wired and/or wireless) for obtaining information from a distributed set of sources (e.g., sensors, monitoring systems, control systems, HVAC systems, elevator systems, security systems, lighting systems, etc.).

The building system 300 also includes at least one robot 316. The robot 316 may be an autonomous or semi-autonomous system that is configured to travel throughout the building and perform tasks, such as inspection, monitoring, data collection, perform maintenance, delivery/transport of items throughout the building, etc. The robot 316 is substantially similar to that described above, having a main body 318, a means for locomotion 320, a sensor assembly 322, and a communications element 324 that is configured to communicate with the controller 314 along a communication line 326. It will be appreciated that the robot 316 is merely schematically shown as a cartoon representation with discrete parts and that the robots of the present disclosure may take any structural form or arrangement of components (e.g., all or some integrated into a single housing or the like). The communication line 326 may be a wireless communication connection and/or the robot 316 may be configured to hardwire connect to a communication port or line to enable communication between the robot 316 and the controller 314.

In this embodiment, a first elevator 304 is configured as a robot-only elevator system, whereas a second elevator 306 is a standard passenger (e.g., human use) elevator. The first elevator 304 may have elevator doors and/or an elevator car that is sized to carry one or more robots and intended for non-human use. The first elevator 304 may be called to a given landing in response to a request from the robot 316. In this configuration, the first elevator 304 is a special-purpose elevator that may be substantially smaller than a conventional passenger-elevator and have certain operational parameters that are not conducive to human use.

For example, the robot-only elevator systems of the present disclosure may be configured with a low profile (e.g., volume) as compared to a conventional system. That is, the elevator car and associated landing doors may be substantially smaller than similar human-use elevator features. The landing doors and the elevator car itself may be sized for carrying one or more robots. In the event that the robot(s) are smaller than humans, the size of the landing doors and the interior space of the elevator car may be reduced proportionally to accommodate the robot(s) without required additional extra space and/or ensuring enough space for additional passengers and the like. For example, typically, a human-use elevator will have predefined bounds of the interior space for passengers (e.g., typical floor space for a 4-passenger elevator is about m² with an allowance in the range of 0.13 to 0.19 m² for each additional passenger). In contrast, no such volume/space minimum requirement is needed to be imposed for robots (other than sufficient size for the robot(s)), and thus the total size/volume of the elevator car for robot-use may be significantly smaller than that of a human-use elevator. In addition or alternatively to a size/volume consideration, the elevator car may be configured based on a duty rating. Typically, there is a standard relationship between duty rating and floor area based on human use. For a robot that is intended to carry dense materials, such a conventional relationship may not hold and the duty rating for a given floor area within the elevator car may be increased. For example, a passenger elevator with interior dimensions or 2.0 m×1.7 m may be rated for 1600 kg. In contrast, for a similar dimensioned elevator car of a robot-use elevator in accordance with a non-limiting example of the present disclosure, a duty rating may be set to handle a larger duty, such as 2500 kg. The increased duty may be to allow for robots to carry loads, or may be based on number/weight of robots that are designed to pack into an elevator tighter without the usual spacing that humans require.

Additionally, the operation of the robot-use elevator may be different from that of a human-use elevator. For example, comfort of a robot is not necessary, and thus certain features may be changed or even omitted in the robot-use elevator as compared to a human-use elevator. Some such features that may be changed or removed in a robot-use elevator are lighting, climate control, ventilation, inclusion of speakers/displays, microphones for voice communication, inclusion of an elevator car operating panel (e.g., buttons and the like), aesthetic interior features (e.g., wall panels, rails, handles, etc.), and the like. In some embodiments, a limited feature interface and/or car operating panel may be included in the robot-use elevator. Such limited feature interface may be configured to enable interaction with a robot, such as through use of an articulated arm or the like, or to allow for access/use by an authorized person (e.g., mechanic) for the purpose of servicing the robot-use elevator.

Furthermore, the robot-use elevator may be configured for operation outside of normal human-use parameters. For example, a robot-use elevator may be configured to travel at speeds not used for humans and/or acceleration/deceleration of the elevator car may be optimized for speed of travel rather than to accommodate a human occupant. Depending on the robot configuration, for example, optimal landing position may not be as critical for such a robot-use elevator as a flush landing may not be required (e.g., depending on mechanism for locomotion of the robot). Jerk, leveling, and stopping may all be adjusted to optimize travel time rather than accommodate human passengers.

It will be appreciated, for example as discussed above, that certain operational parameters (e.g., speed/acceleration/jerk), climate, lighting, passenger interface affordances (e.g., speaker, signage, microphones for voice communication, etc.), and the like may be omitted or modified for implementation with a robot-only elevator. Further, it will be appreciated that such elevators are not to be bound by adherence to codes for passenger elevators (e.g., human-use elevators). As known in the art, various authorities (e.g., governments) may promulgate codes, standards, rules, regulations, or the like that govern safety standards or other aspects, features, and properties associated with human-use elevator systems. These codes, for example, may mandate a fully enclosed cab, ventilation, affordances for trapped passengers, minimum size limitations to accommodate a wheelchair user to board and turn the wheelchair around, redundant safety measures, etc. Such mandates may not be applicable to elevator cars of the present disclosure. That is, elevators for robots, in accordance with some embodiments of the present disclosure, are not suitable for human use. Although such codes may vary from region to region (e.g., the code followed by most of Europe differs from North America and many Asian countries) and local variations even within a region, such codes and structural and/or functional limitations imposed thereby may not be applicable to elevators as disclosed herein.

With respect to operational parameters, for example and without limitation, typical human-use elevators may be limited to a maximum speed in the down direction of 7 m/s (sustained) and rarely above 9 m/s even if this descent speed is reached briefly. Such speed limitations are imposed due to the limitations of the inner ear of a human to adapt to pressure changes during descent. Further, for example, regarding acceleration and jerk, human-use elevators typically do not exceed 2.0 m/s 2 and 4 m/s³, respectively, with normal levels for comfort being about 0.8 m/s² (up to 1.2 m/s²) and 1.2 m/s³ (up to 2.5 m/s³). These limits on speed, acceleration, and/or jerk need not be imposed upon the robot-use elevators of the present disclosure, and thus faster travel and/or more abrupt start/stop may be used, thus providing advantages over conventional elevators systems.

In addition to increased travel speeds, the other extreme is also true for robot-use elevators. That is, an elevator that is very slow may be employed in robot-use elevators. The slow speeds may be unacceptable (e.g., excruciating) for humans but may be acceptable for robots, and may provide cost benefits through simplicity and/or lower cost components and/or power use due to slower speeds. Besides being cheaper, there may be cases in a zero-energy building or where power draw may be time/duration limited (e.g., when a lot of passenger elevators are drawing power) such that the robot-use elevator is only operated when there is available power. As a result, the robot-use elevator may be delayed or slowed down temporarily or even interrupted temporarily (e.g., instead of making a nonstop run from floor X to floor Y, the car comes to stop somewhere along the way to conserve power and resumes later when power is available). Humans typically will not tolerate such delays, slow speeds, and/or stops and will be very concerned (even panic) if they suspect the elevator is not working properly. Such considerations may not be applicable to robot-use elevators.

In accordance with embodiments of the present disclosure, the robot-use elevator may have a number of distinctions as compared to human-use elevators. As noted above, relatively high speeds (or derivatives thereof) may be used in a robot-use elevator as compared to the limits imposed on speeds necessary to accommodate human-use (e.g., pressure changes in human ear). Additional operational parameters may include, without limitation, lack of need for lighting (e.g., elevator car with no lights), and lack of need for ventilation (e.g., robots do not need fresh/circulated or conditioned air). Further, the robot-use elevators of the present disclosure may be configured to operated outside of national or local codes, ordinances, and requirements that are imposed upon human-use elevators. For example, in the US, all elevators must meet a certain code (e.g., ASME A17.1 Safety Code for Elevators and Escalators or its successors). There are equivalent codes in the rest of the world (e.g., European EN81 code). Various of the requirements for human-use elevators may be ignored for robot-use elevators of the present disclosure, such that the operational parameters may be optimized for other considerations (e.g., speed, cost, etc.) without creating risks associated with operating outside of the codified limits.

For example, and without limitation, in a robot-use elevator, there may be no need for emergency communication devices onboard the robot-use elevator or in the associated elevator hoistway (e.g., no need for microphone for voice communication, speaker, emergency call button, etc.). Even if a form of emergency communication is necessary for a robot-use elevator, the conventional mechanisms may be avoided. For example, any communication between the robot and an elevator controller can be done wirelessly or through other communication/connection means that is not the typical buttons, microphones for voice communications, speakers, etc. As such, the simplicity of the robot-use elevator configuration may be increased.

Additionally, there may be no need for any hall fixtures (e.g., hall call buttons, telltale lights, direction lanterns, position indicators, etc.), passenger affordances for car status (e.g., telltale light that a call has been entered, indication of where a car is located, direction of car travel, etc.), or signage (e.g., visible and tactile in the form of Braille). In the case of hall call panels and associated components at landings, it will be appreciated that one or more landings of a robot-use elevator system may include a hall call panel (e.g., fire operation panel, etc.). As such, one or more landings of a robot-use elevator may include a hall call panel while other landings of the same robot-use elevator may not include such panels. Typically, the codes and rules governing human-use elevators assume the necessity of call fixtures that require audible and visible signals to the passenger which would not be required for robot-use elevators of the present disclosure. Furthermore, there may be no need for a car operating panel or any human-interface fixtures inside the elevator car. The conventional human-interface fixtures may be replaced by direct communication (e.g., wirelessly) between the robot and the elevator controller.

In addition to functional features/fixtures that may be eliminated or modified (e.g., operating panels, lights, audio components, etc.), the physical structure and configuration of the robot-use elevator car may be changed to be outside the limits of human-use elevators. For example, the car door dimensions of a robot-use elevator may be set to dimensions that are not suitable for humans, but are designed for robot-use. For example, current codes may require specific door widths and heights to accommodate human use, including, but not limited to, wheelchair access. In an example of such human-use elevator requirement, the car doors may be required to have a width of at least 36+/−⅝ inches, and a door opening that is at least 16 square feet. For a robot-use elevator, such width and/or door opening area may be well outside (even significantly smaller) these human-use regulations. Similarly, the dimensions of the elevator lobby of a robot-use elevator system may be outside the requirements that are acceptable for human-use. For example, codes may require that at least 60 inches of space are provided in front of a hall call button. This minimum space may be completely eliminated for robot-use elevator systems. In robot-use elevator systems, particularly those that employ small robots, the corridor to access the robot-use elevators need not comply with the minimum space requirements imposed on human-use systems. As such, the amount of floor space at each landing may be reduced as compared to human-use systems.

Further, specific operational parameters may be modified for robot-use elevators that are not acceptable for human-use systems. For example, there is no need for a timer that ensures elevator doors are held open for at least a minimum time. In human-use systems, at floors where an elevator has been called, there must be enough time to allow boarding according to basic human expectations (e.g., codes set a minimum of 3 seconds, or longer, in response to a call for typical passenger elevators, and even longer for certain classes of elevators. In a robot-use elevator system, the robot may itself define the door open period in a request for elevator use (e.g., wireless transmitted to elevator controller). As such, the hold time of the doors may be robot-specific, where a first robot of a building system may require a very short period of time (e.g., 1 sec) to board, as it may be ready and have means of locomotion that allow rapid boarding, and thus the hold time at each landing may be reduced. However, a second robot of the building system may be slow, large, or have some other restriction where the time to board is significantly longer (e.g., 10 seconds or more). This longer time would not typically be permitted for human-use elevators due to delays such hold period would impose. However, with the robot-use elevators of the present disclosure, increased hold times has no impact on passengers (as there are none). Alternatively still, the hold time may be set to infinite (or no hold time present at all) on a robot-use elevator, and the system may be configured to await confirmation from the robot that boarding has been successful, prior to closing the doors. That is, the door operation may be completed changed due to the direct communication connection between the robot an the elevator controller.

Further, for human-use elevators, a door closing speed is governed by a momentum limit (speed times mass) so that, should a closing door strike a person, it will not unduly injure the person. This is the reason why door closing times are typically longer than door opening times (which have no such limit). Such a consideration may be eliminated or adjusted as it may be possible (though not necessary) to close the doors faster without regard to the limitations designed for human use. The time savings that may be achieved through increased door close speeds, along with faster travel speeds, may be important to improve throughput and system efficiencies. Robot-use elevators may also take full advantage of “advance door opening” where it is possible to begin opening the doors before the elevator car is level with the floor. Typically, the elevator car needs to be within a door zone, where being in the door zone corresponds with a floor/platform of the elevator car being within 6 inches or so of the floor at the landing. This feature is helpful because it saves time (e.g., between 0.5 seconds to 1.0 seconds) before the elevator car is completely level. In human-use elevators, although this feature may be used, it is typically disabled because passengers may complain if they see the doors begin to open when the car is not level with the landing. As such, human-use elevators typically do not fully leverage the advance door opening feature. However, with a robot-use elevator, there are no passenger concerns regarding advance opening and it may be possible, in some embodiments, to extend the door zone beyond the typical+/−6 inch limit for advance door opening, which may provide additional time savings to each stop made by the robot-use elevator.

In addition to removing or eliminating features from human-use elevators, embodiments of the robot-use elevators of the present disclosure may include robot-use features and fixtures. For example, the elevator car may be configured with a power source or the like and a provision for charging/recharging the robot while in the elevator may be provided. Such power sources can include, without limitation, power receptacles, inductive power transfer, and the like. Similarly, docking or data transfer may be achieved through ports, connections, wireless communication, or the like, when the robot is located within and/or riding on the robot-use elevator.

As described herein, the robots may be configured for wireless communication with an elevator controller or other elevator or building system. As discussed, the robot may be configured to make elevator call requests to the controller through the wireless communication. It will be appreciated that the wireless connection and communication may be more than just making elevator call requests. For example, the connection/communication can also include communicating status information such as: the robot indicating where it is located (e.g., so the elevator system can plan which elevator to assign), the robot indicating that it has successfully boarded or deboarded (e.g., so the elevator controller knows it can close the doors and move), the elevator controller telling the robot which elevator has been assigned (e.g., so the robot knows which doors to enter), etc. That is, additional mechanisms and processes may be achieved through the direct connection/communication between the robot and the elevator system to improve operation thereof.

In operation, in some embodiments, the robot-use elevator (elevator 304) may be configured to be called by the robot 316 and/or directed by the controller 314 without human intervention. In some embodiments, the robot 316 may be configured to make an elevator call request through the communication line 326. In response to such a request, the controller 314 may be configured to dispatch the first elevator 304 to the requested landing. The request from the robot 316 may include a destination as well. As such, the request from the robot 316 may be a complete request with starting landing and destination landing included in a single request. The request from the robot 316 may also identify the requesting source (i.e., the robot 316) such that the controller 314 can dispatch the first elevator 304 to fulfill the request, and thus does not interfere with the normal use of the second elevator 306 (human-use elevator).

In some embodiments, the originating landing and destination landing may be included in a request from the robot 316. However, in other embodiments, the controller 314 may be configured to control operation of the robot 316, at least in part. That is, the controller 314 may both schedule an elevator call using the first (robot-use) elevator 304 and also transmit instructions to the robot 316 for execution by the robot 316. This configuration is different from a robot having onboard instructions and making a request. In this configuration, the robot does not make requests, but receives instructions from the controller 314 and performs a task or action in requires to such instructions.

In some embodiments in accordance with the present disclosure, the robots may be configured to use human-use elevators but may be able to modify or request alternative operational parameters for the elevator. For example, if the robot 316 enters the second elevator 306, and no passengers are present, the robot 316 may inform the controller 314 (or the controller 314 may already have such information, such as from other sensors or the like). When it is only a robot within the elevator car, the elevator car may be operated outside of normal operational parameters. For example, a typically human-used elevator may be operated at higher speeds, increased accelerations/decelerations, etc. Additionally, when only robot(s) occupies the elevator, no human-based features may be required. For example, the lighting, sound, visuals, and the like may be disabled. Additionally, climate control, ventilation, and the like may be disabled, or not enabled. Such control and alternative operational parameters may be used, for example, during after-hours of a building (i.e., no humans expected to be present). It will be appreciated that this functionality may be employed, for example, in systems that don't include a specific robot-only elevator (e.g., as shown in FIG. 2).

When robots are using the elevator system, a dispatch logic and control of the elevator system may be modified. For example, the stop-order of a robot-use elevator may be different than that controlled for humans. In a human-use system, the elevator car will typically travel in a single direction for a series of calls, and not make unnecessary stops or changes in travel direction. In one example, a first passenger may wish to travel from an originating floor to a destination floor. When the passenger is traveling from the originating floor to the destination floor, the elevator car will only stop at landings where additional passengers have made an elevator request and indicate they will travel in the same direction as that from the originating floor to the destination floor. If the new passenger requests to travel in the other direction, the elevator car with the first passenger will not stop. After delivering the first passenger to the destination floor, the elevator car may then travel back to the floor with the new passenger.

In contrast, with a robot-use elevator operation, the elevator car may stop at any floor to pick up additional robots or may even change direction based on a request from a second robot. In the control logic, human considerations may be ignored. As such, priority may be given based on specific requests and a priority logic that is part of the request from the robot and/or part of the controller system. The control logic can include scheduling in addition to various other parameters, as discussed above, such as speed, acceleration control, and the like. In some configurations, such scheduling may include bypassing one or more robots even if under normal human-use operation such a stop may be made. That is, the controller 214 can schedule stops of the elevator car for optimal workflow and/or based on some other type of criteria that is not related to human-use.

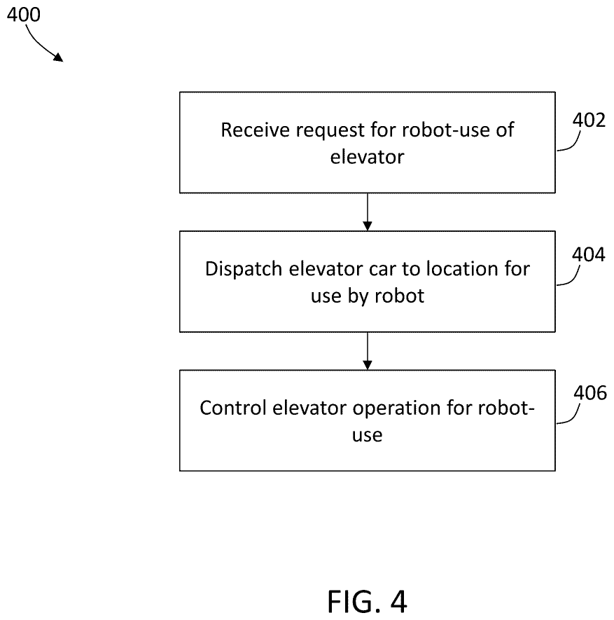

Turning now to FIG. 4, a flow process 400 for performing elevator associated with an elevator system of a building in accordance with an embodiment of the present disclosure is shown. The flow process 400 may be performed using a control system, an elevator system, and a robot, similar to the configuration shown and described above. The robot may be an autonomous or semi-autonomous system that is capable of moving throughout a building and interact with system of the building, including, but not limited to, an elevator system. The robot may be a general purpose robot configured to perform a variety of tasks associated with the building, a dedicated robot configured specifically for tasks and operations associated with an elevator system or may be a robot that is not directly associated with the building but brought on-site for one or more purposes. The control system that implements a portion of the flow process 400 may be an IoT (internet-of-things) control system associated with the building, and specifically associated with the elevator system of the building.

At block 402, a request for robot-use of an elevator is received at the controller. The request may be initiated by the robot, making a request to travel from one floor to another or to board an elevator car to inspect the elevator car or perform some other action within the elevator car. In some configurations, the request may be received at the controller from an internal storage or other associated database that provides the controller with information regarding a task to be performed that requires use and operation of the robot. As such, the received request may not come from an external location apart from the controller itself. In some embodiments, the request information may include transmitting instructions from the controller to the robot to call the robot to an appropriate landing and elevator of an elevator system.

At block 404, an elevator car is dispatched to a location for use by the robot. The dispatch may be of a robot-use elevator (e.g., as shown in FIG. 3) or may be a human-use elevator (e.g., as shown in FIG. 2). In the case of human-use elevator, the controller or components associated therewith, may be configured to detect, and ensure that no humans are present within the elevator car prior to dispatching the elevator car to the robot. Such detection may be by optical inspection, proximity sensors, weight sensors, and the like. If the system uses a human-use elevator, the controller may be configured to control the elevator car to travel based on parameters that are outside normal human use (e.g., speed, acceleration, deceleration, etc.).

The dispatching step at block 404 may optionally include transmitting from the controller to the robot assignment information. That is, a communication to the robot regarding an assigned elevator car may be received at the robot. As such, the robot may position itself relative to the assigned elevator car and/or be prepared to board the specific assigned elevator car. As such, the dispatching at block 404 may involve multiple sub-steps, including assigning an elevator car to a request from a robot, sending confirmation and/or elevator car assignment information to the robot, and controlling the elevator car to travel to the requested floor to pick up the robot.

At block 406, once the robot enters the elevator car, the elevator car may be controlled to travel to a destination designated in the request (block 402). The control of the elevator car may be based on the fact that a robot is the passenger, as compared to a human occupant. Such a robot-use elevator control may include travel speeds not used for humans and/or acceleration/deceleration of the elevator car may be optimized for speed of travel rather than to accommodate a human occupant. Further, optimal landing position may not be as critical for such a robot-use elevator. Jerk, leveling, and stopping may all be adjusted to optimize travel time rather than accommodate human passengers. Additionally, various comfort parameters may be omitted or changed. For example, when a robot is traveling within an elevator car there is no need for climate control, ventilation, lighting, display, audio or sounds, or the like. If a dedicated robot-use elevator is employed, these features may be omitted in the construction and installation thereof. If a human-use elevator is used with a robot passenger, then the features may be disabled as appropriate and/or the elevator may be driven at parameters outside normal human comfort.

In accordance with embodiments of the present disclosure, maintenance and/or inspection requests may be received from analysis of IoT data or from a human-derived request (e.g., customer, passenger, mechanic, etc.). The analysis of the request may, in part, be based on comparing collected data against a database of normal operating parameters or the like. Such a database may be located anywhere as long as such database is accessible by the building monitoring system and/or the robot. For example, such database(s) may be stored in cloud storage (e.g., distributed/networked storage), in a machine room of the building (e.g., elevator machine room), in on-site or off-site servers, in the robot itself (e.g., onboard digital memory), or the like.

The robots described herein and employed with embodiments of the present disclosure may include various features and/or functionalities to perform the tasks described herein. For example, the robots may be self-propelled or mobile. The locomotion of the robots may be through self-control and driving a motor or the like that drives wheels, treads, legs, or the like to move the robot throughout the building. The robot may include onboard storage with a digital map or layout of the building, or, in some embodiments, the robot may be configured with optical sensors (or the like) to enable self-locomotion based on observed conditions from such onboard sensors. The robot will include various sensors for performing requests tasks or actions, such as inspection and/or to perform a task such as operating a tool or interacting with components of the elevator system. The robot will also include an interface for communication with the control system, and thus can receive data from a database and/or instructions from the control system.

In some embodiments, the robot may be configured and programmed to be substantially autonomous both in terms of locomotion and in performing tasking. For example, the sensors of the robot may be configured to actively (e.g., continuous or at intervals) collect and analyze data (e.g., onboard or transmitted to a building monitoring system for analysis). The robot may also be configured or programmed to respond to conditions that are detected or observed by the sensors and adjust the tasks the robot performs based on such obtained information. That is, the robot may be configured to do more than merely follow a checklist or set of instructions, but rather may be configured to adaptively adjust based on real-time data collection.

Advantageously, embodiments of the present disclosure provide for integrated building systems that incorporate a robot. By leveraging robots in a building, routine or triggered checks on certain elevator equipment as performed by the robot(s) can help resolve potential issues quickly by providing an additional, early validation of a potential issue. Advantageously, an elevator designed solely for robot use can increase productivity and add value within a building. For example, such a dedicated robot-only elevator system may employ a smaller sized elevator car and hoistway (e.g., elevator shaft) for a potential reduction of the core of the building. Further, advantageously, such elevator cars may be lighter in weight, with a lower weight allowance saving on part/component wear, reduced cost, etc. Additionally, as described herein, robot-use elevator systems can enable faster car travel speeds, greater acceleration and deceleration speeds, reduced bounce/leveling requirements, and the like.

Further, advantageously, such elevators (robot-use) may have minimal features that are normally present in human-use elevators. For example, a robot-use elevator may not include a conventional car operating panel and/or hall call panel, may have minimal or no lighting, have no climate control (or minimal climate control) and/or ventilation, and may not include aesthetic or information features such as wall panels, displays, speakers, microphones for voice communication, and the like. In some embodiments, the robot-use elevator may be an elevator system configured to lack of a way for a human to call an elevator intended for the robots. As such, the robot-use elevator system may not include any hall call panel(s) at landings of the elevator systems or other mechanisms for humans to call the elevator (e.g., destination entry kiosks or the like). In such embodiments, the robot may be configured to call the elevator car not using standard hall fixtures but through an alternate communication method (e.g., wireless interface to the elevator controller or the like). In some embodiments, the elevator system may be configured such that any interfaces used by a human are never allowed to call a robot-use elevator to be assigned to answer a passenger call. Further for example, for an elevator group formed only of robot-use elevators may not include any hall fixtures, thus preventing human use of the elevator system.

The prevention of human-use of such robot-use elevators may be implemented through lack of call buttons, but may also or alternatively include other prevention mechanisms. For example, in some embodiments, the robot-use elevator cars may be configured with sensors or the like that are configured distinguish a robot that is intended to board the elevator from others, such as humans (or unauthorized robots). In some embodiments, an authentication process (e.g., handshaking requirement before the elevator doors open at a requested landing) may be employed. Further still, imaging and analysis can be used to perform an optical or other analysis to determine if the potential user is a robot or not (or at least determine if the call is made by a human). A near-field connection may also be a validation process such that the robot-use elevator can only travel with an occupant (e.g., determined by weight or other detection) if such occupant includes or carries a predetermined tag or the like, with such tags carried on or part of the robots that are permitted to use such robot-use elevators. It will be appreciated that other prevention mechanisms may be employed without departing from the scope of the present disclosure. Various systems of the present disclosure may include robot-verification and/or lack-of-human verification, or combinations thereof. That is, the controllers of the systems may be configured to perform a check or validation of both a request for elevator call (e.g., through handshake or the like) and perform a check upon arrival at a landing. At the landing, imaging or other checks may be performed prior to opening doors to the robot-use elevator. In some configurations, even after opening the elevator car doors, a check regarding the occupancy of the elevator car may be performed (e.g., using optical analysis, handshakes, NFC, Bluetooth, tags, or the like). Various types of sensors may also be useful for such validation or check, including microphones to detect voices/breathing, infrared detectors to monitor for body heat, or the like.

Additionally, the control of such systems may employ dispatching logic based on robot delivery priorities and utilization, instead of passenger-oriented goals for traffic flow or comfort. For example, the robot-use elevator may employ increased wait times at a given floor (e.g., waiting for one or more robots) which would not be acceptable for human passengers (e.g., 1 minute or greater). Additionally, in accordance with some embodiments, the robots may be integrated into and/or in communication with an elevator system to enable calling and control of elevator cars and/or other parts of the elevator system. Such communication may be directly communicated from the robot to an elevator controller or may be through other communication channels, such as through a controller, building maintenance system, IoT system, or the like.

The terminology used herein is for the purpose of describing particular embodiments only and is not intended to be limiting of the present disclosure. The terms “about” and “substantially” are intended to include the degree of error associated with measurement of the particular quantity and/or manufacturing tolerances based upon the equipment available at the time of filing the application. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

Those of skill in the art will appreciate that various example embodiments are shown and described herein, each having certain features in the particular embodiments, but the present disclosure is not thus limited. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

What is claimed is:

1. A building system comprising:
a robot-use elevator system having an elevator car moveable along an elevator shaft of a building;
a controller configured to receive requests associated with the elevator system and configured to control operation of the elevator system; and
a robot configured in communication with the controller and configured to perform actions within the building, the robot configured to travel within the building in the elevator car,
wherein the elevator car is operated using parameters outside limits intended for human use of an elevator car.

2. The building system of claim 1, wherein the parameters comprises at least one of elevator travel speed, elevator acceleration rate, elevator deceleration rate, elevator jerk, and elevator leveling at a landing.

3. The building system of claim 1, wherein the parameters comprises at least one of climate control within the elevator car and lighting within the elevator car.

4. The building system of claim 1, wherein the elevator car is a robot-use elevator car configured to transport robots and not humans.

5. The building system of claim 4, wherein the robot-use elevator car does not include at least one of a car operating panel, an in-car display, an in-car speaker, an in-car microphone for voice communication, or a hall call panel.

6. The building system of claim 1, wherein the robot-use elevator car is sized for carrying the robot and not humans.

7. The building system of claim 1, wherein the robot is configured to make elevator call requests to the controller through a wireless communication.

8. The building system of claim 1, wherein the controller is configured to verify that a request for use of the elevator car is made by the robot as compared to a human request.

9. The building system of claim 1, wherein the controller is configured to verify that no humans are present in the elevator car prior to causing movement thereof.

10. The building system of claim 1, wherein the robot-use elevator system does not include a hall call panel for human-use calling of the elevator car at one or more floors where the elevator can be called by the robot.

11. The building system of claim 1, wherein the robot is configured to perform a handshake operation with the controller prior to traveling within the elevator car, and wherein the elevator car is configured to not travel if the handshake operation is not performed.

12. A method of controlling an elevator system comprising:
receiving a request for elevator service from a robot at a controller;
dispatching an elevator car to a location associated with the request for elevator service; and
operating the elevator car using parameters outside limits intended for human use of an elevator car.

13. The method of claim 12, wherein the parameters comprises at least one of elevator travel speed, elevator acceleration rate, elevator deceleration rate, elevator jerk, and elevator leveling at a landing.

14. The method of claim 12, wherein the parameters comprises at least one of climate control within the elevator car and lighting within the elevator car.

15. The method of claim 12, wherein the elevator car is a robot-use elevator car configured to transport robots and not humans.

16. The method of claim 15, wherein the robot-use elevator car does not include at least one of a car operating panel, an in-car display, an in-car speaker, an in-car microphone for voice communication, or a hall call panel.

17. The method of claim 15, wherein the robot-use elevator car is sized for carrying the robot and not humans.

18. The method of claim 12, further comprising transmitting from the robot a handshake request to the controller prior to operating the elevator car.

19. The method of claim 12, further comprising verifying, with the controller, that a request for use of the elevator car is made by the robot as compared to a human.

20. The method of claim 12, further comprising verifying that no humans are present in the elevator car prior to causing operation thereof.
